(19) United States
(12) Patent Application Publication
(10) Pub. No.: US 2007/0234634 A1
(43) Pub. Date: Oct. 11, 2007

(54) Article of Fishing Tackle and Method of Making Same

(76) Inventor: Harold F. Beal, Rockford, TN (US)

Correspondence Address: PITTS AND BRITTIAN P C, P O BOX 51295, KNOXVILLE, TN, 37950-1295, US

(21) Appl. No.: 11/697,487

(22) Filed: Apr. 6, 2007

Related U.S. Application Data
(60) Provisional application No. 60/790,358, filed on Apr. 7, 2006.

(51) Int. Cl. A01K 95/00

(52) U.S. Cl. 43/43.1; 43/44.87; 43/44.9

(57) ABSTRACT

An article of fishing tackle which exhibits one or more of the physical properties of a heavy metal such as tungsten, tantalum, depleted uranium etc., their carbides, alloys thereof, and/or mixtures thereof. The article of the present invention comprises a quantity of a powdered heavy metal, either alone or in combination with a further powdered metal, of like or disparate physical properties, compressed, as by die forming, at room temperature and without sintering to produce a self-supporting compact. The article may comprise a sinker, a lure or combination thereof.

### CROSS-REFERENCE TO RELATED APPLICATIONS

This application claims the benefit of U.S. Provisional Application No. 60/790,358, filed Apr. 7, 2006.

### STATEMENT REGARDING FEDERALLY SPONSORED RESEARCH OR DEVELOPMENT

Not Applicable

### FIELD OF INVENTION

This invention relates to articles of fishing tackle and specifically to lures and sinkers (the latter at times being referred to as “weights”).

### BACKGROUND OF THE INVENTION

Herein, at times the term “sinkers” is intended to include “lures” as the context suggests.

Sinkers desirably are of maximum weight per unit of volume (density) and of optimized geometry (related to movement of the sinker through water). Heretofore, lead has been the metal of choice for forming sinkers, primarily due to its relatively low cost and the ease with which it can be formed into various sizes and geometries. Lead, however, has been found to be deleterious, even deadly, to various creatures living in or around fishing areas so that it is desired that lead be eliminated from fishing lures and/or sinkers.

Sinkers and lures commonly are attached to other fishing gear, such as fishing lines, employing holes, slots, etc. formed through or in the sinker whereby the sinker may be threaded onto or otherwise attached to the fishing line. Sinkers of solid heavy metals present problems of severing commonly known fishing lines dues to sharp edges on the sinker, or the like.

In the prior art, it as common to form lead sinkers by melting lead and pouring the same into molds. Upon cooling and solidification of the lead, the sinker(s) is/are removed from the molds. Most commonly, the sinkers exit their mold shaped and prepared for attachment to a fishing line or the like. Heavy metals such as depleted uranium, tantalum and tungsten, their carbides and/or alloys thereof are relatively expensive relative to lead, but offer several advantages over lead, particularly their relatively greater densities. Forming of such heavy metals, however, employing prior art metallurgical techniques requires relative strong (heavy) and expensive manufacturing equipment costs due to the type and size of equipment required to form such metals into various shapes and sizes. This latter factor is especially important in that sinkers are generally deemed to be expendable by reason of their tendency to be lost or destroyed in the course of their normal mode of use. Moreover, the need for a large range of sizes and shapes of sinkers and lures exacerbates the manufacturing equipment costs and processes.

Further, desirably sinkers in particular are to be of a geometry which minimizes their resistance to movement through water. Sinkers, for example, desirably move through water with minimum resistance, hence greater speed, so that associated fish bait can be rapidly delivered to a prospective location of fish. This fishing technique is particularly useful in deep sea fishing.

### SUMMARY OF INVENTION

In accordance with one aspect of the present invention, there is provided an article of fishing tackle, or other object for which it is desired that the object exhibit one or more of the physical properties of a heavy metal such as tungsten, tantalum, depleted uranium etc., their carbides, alloys thereof, and/or mixtures thereof. The article of the present invention comprises a quantity of a powdered heavy metal, either alone or in combination with a further powdered metal, of like or disparate physical properties, compressed, as by die forming, at room temperature and without sintering to produce a self-supporting compact.

### BRIEF DESCRIPTION OF THE FIGURES

FIG. 1 is a representation of a sinker embodying various of the features of the present invention, including a straight throughbore extending through the sinker;

FIG. 2 is a representation of a tubular line protector adapted to be fitted within the bore of the sinker depicted in FIG. 1;

FIG. 3 is a representation of a sinker having a tortuous bore extending through the sinker;

FIG. 4 is a representation of one embodiment of a sinker having a tapered central bore through the length thereof;

FIG. 5 is a side view representation of a sinker of a generally flat body portion and a curved trailing end portion, and depicting a fishing hook associated therewith to provide a combination sinker/lure;

FIG. 6 is top plan view of the sinker/lure depicted in FIG. 5;

FIG. 7 is a representation of a single cylindrical sinker and depicting the attachment of the sinker to a snap connector adapted to affix the sinker to a fishing line;

FIG. 8 is representation of a plurality of like-sized disc-shaped elements which are stacked to collectively define one embodiment of a sinker of the present invention;

FIG. 9 is a representation of a plurality of differently sized disc-shaped elements which are stacked to collectively define another embodiment of the a sinker of the present invention;

FIG. 10 is a representation of a sinker having a snap hook which encircles the length of the sinker;

FIG. 11 is a representation of a further embodiment of the sinker and snap hook depicted in FIG. 10 and including an external groove formed in the sinker and into which the snap hook resides; and,

FIG. 12 is a schematic flow chart depicting one embodiment of the method of the present invention.

### DETAILED DESCRIPTION OF INVENTION

In accordance with one aspect of the present invention there is provided an article 12 of fishing tackle in the form of a compressed compact 18 of a powdered heavy metal such as tungsten, uranium, tantalum, and carbides and alloys or other combinations of the class of heavy metals taken from the commonly known chart of the elements (referred herein at times as “heavy metal” or “heavy metals” for convenience purposes). As desired, the articles of the present invention also may be formed from either a mixture of powdered metals, or preferably from essentially 100% of a given powder, including powdered heavy metal, such as powdered tungsten, for example, a powdered light metal such as powdered tin, for example, or a non-metallic powder such as a ceramic or polymeric powdered material, for example.

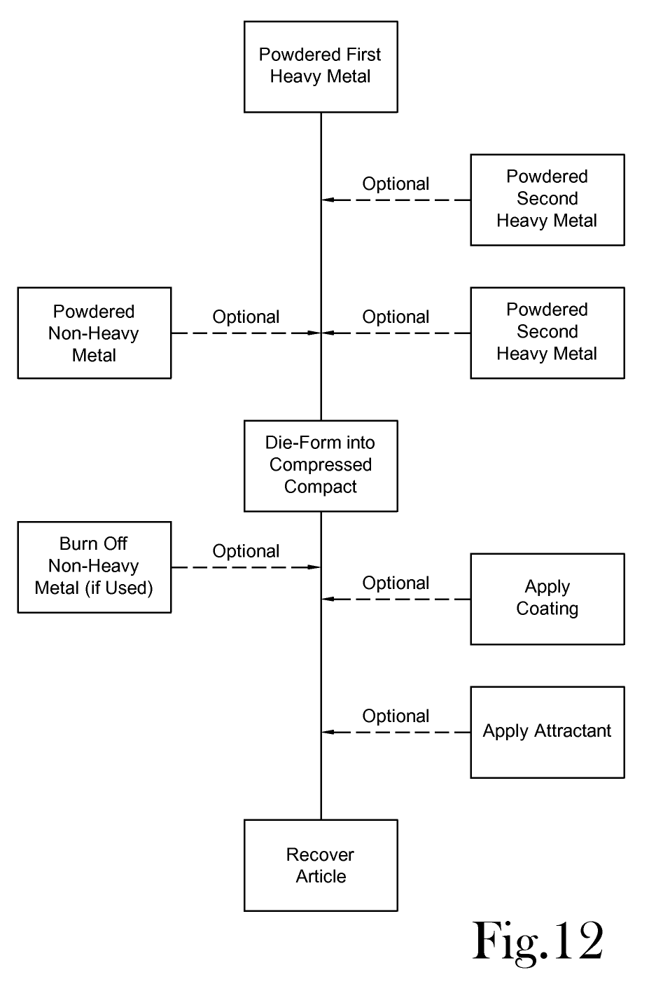

As depicted in FIG. 12, an article of the present invention may be formed by a process of die-forming a quantity of a powdered heavy metal (100% heavy metal) or a mixture of a powdered heavy metal with a powdered non-heavy metal, such as tin, lead, iron, aluminum, and like powdered metals or mixtures or combinations of such powdered non-heavy metals.

In one embodiment, a sinker 14 of the present invention is die-formed at room temperature from either 100% powdered tungsten or. a mixture of powdered tungsten metal and a non-heavy metal powder. In such mixtures, the tungsten may range from 100% tungsten to as little as about 10% powdered tungsten metal, by wt., the remainder being powdered non-heavy metal. Tin is especially useful as the non-heavy metal of the mixture. In the die-forming operation, one need only employ pressure values sufficiently high as will result in mechanical bonding of the tungsten powder particulates one to another to define self-supporting compressed compact 18 of a selected geometry. In a mixture of powdered tungsten metal and powdered tin metal, one may select a desired size sinker having a desired density for such given size (and/or geometry), by selecting the percentage of tungsten employed in the mixture of metal powders. Obviously, larger amounts of tungsten powder in a weight creates a relatively overall heavier sinker for such given size.

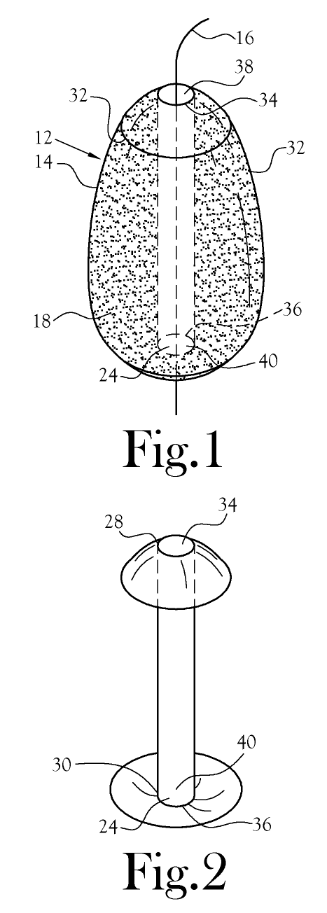

In one embodiment of the present invention, a quantity of powdered tungsten metal, preferably of about 325 mesh particulate size is placed in a die formed into a self-supporting integral sinker of any of a large variety of geometry. One preferred geometry is a “tear” shaped sinker 14 such as depicted in FIG. 1.

When employing powdered tungsten metal, either alone or in a mixture with a non-heavy powdered metal, the powder mixture preferably is admixed with a dry polymeric matrix powder such as polyethylene powder having a particle size of about 10 microns, for example, A-12 micronized polyethylene powder available from HoneyWell of Morristown, New Jersey, in an amount of between about 0.1% and about 1.2%, by weight, based upon the overall weight of the powder mixture.

Depending upon the percentage of a given powder employed, either in a mixture of powders or a single powder, and the size of the desired final product, among other things, pressing pressures may range as low as about 100 psi to pressures exceeding 75,000 psi. No sintering of the compressed compact is required and none is desirable.

Referring initially to FIGS. 1 and 2, for attaching of a sinker 14 of the present invention to a fishing line 16, the compressed compact 18 may be formed with a throughbore 24 extending through a selected portion of the compact, such as centrally of the length dimension, for example, of the compact as depicted in FIG. 1. As needed the throughbore may be fitted with a hollow tubular lining 26 (FIG. 2) such as a tube of a polymeric or mallable metal material. Preferably, after the liner has been inserted into the throughbore, the opposite ends 28 and 30 thereof project out of the opposite ends 28 and 30 of the throughbore in position to be flared and folded back upon the outer surface 32 of the compressed compact adjacent the respective ends of the throughbore and overwrapping the rims 34 and 36 of the respective ends 38 and 40 of the throughbore to protect the fishing line from chaffing or being severed by reason of the line rubbing against either of the rims of the open opposite ends of the throughbore.

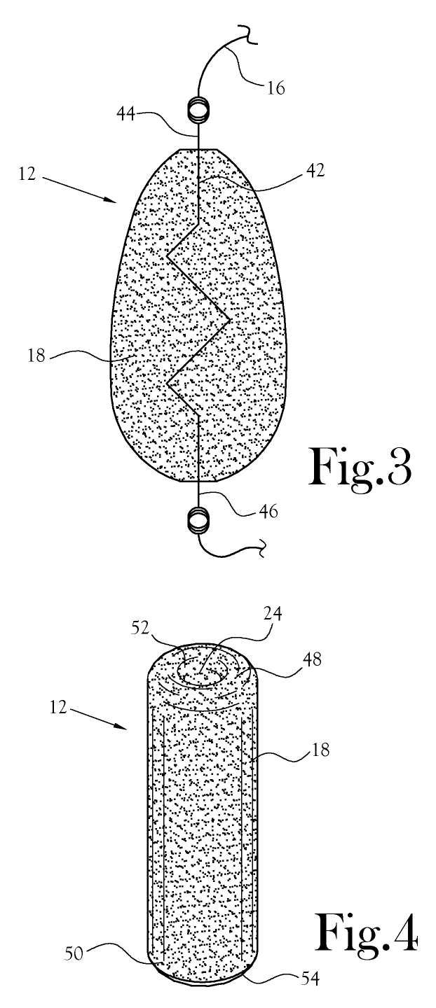

Alternatively, a thin wire may be formed as a part of the compressed compact 18 in the die-forming process. FIG. 3 depicts one embodiment of a sinker as depicted in FIG. 1 but having a brass wire 42, for example, embedded within the compressed compact along the length dimension of the compact with opposite end portions 44, 46 of the wire projecting from the opposite ends 48, 50 of the compact for purposes of connecting the sinker to a fishing line. Various suitable wire snap-type fasteners 64 for attaching a sinker to a fishing line are well known in the art.

As depicted in FIG. 4, as desired, the compressed compact 18 defining the sinker may include a hollow central throughbore 24 of a large range of internal diameters. By this means, one may choose the overall weight of the sinker as a function of the internal and external diameters, hence the wall thickness, of the compressed compact. Further, as depicted in FIG. 4, the opposite ends 48, 50 of the pressed compact may be provided with a smooth crown 52,54, respectively, suitable to preclude chaffing or the like of a fishing line threaded through the throughbore.

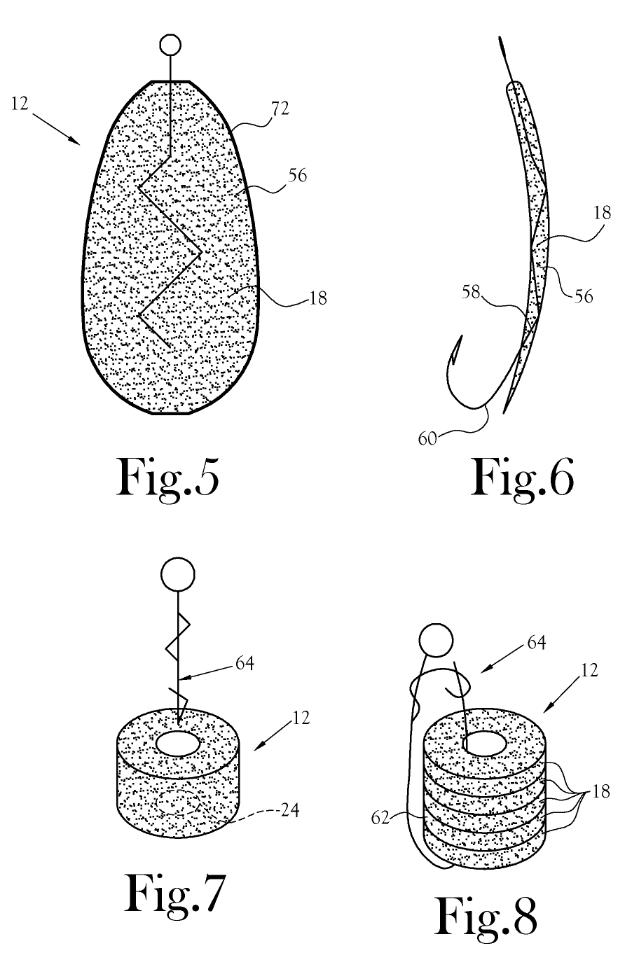

In a still further embodiment of the present invention, as seen in FIGS. 5 and 6, the compressed compact 18 may take the form of a generally planar elongated body member 56 of a geometry known in the fishing art as a “spoon” shape. In the depicted embodiment of FIGS. 5 and 6, the body member is formed with the shank 58 of a fishing hook 60 embedded within and extending along the length dimension of the body member.

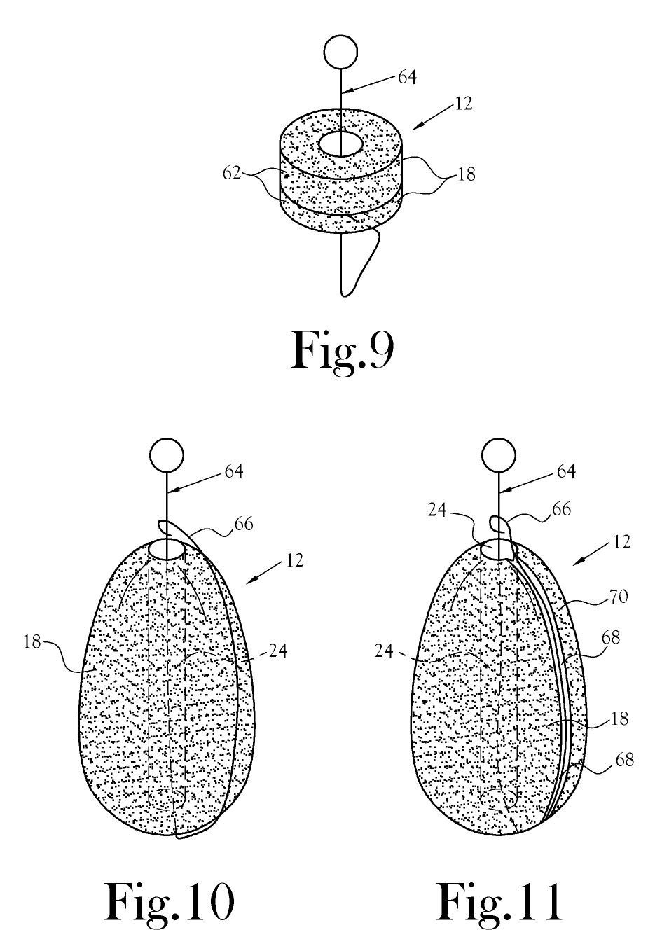

As desired, in one embodiment of the present invention, the throughbore of the sinker may be fitted with a snap line fastener 64 as depicted in FIGS. 7, 8 and 9. As depicted in FIG. 7, a single flat disc-shaped compressed compact 18 may be threaded upon a snap line fastener 64. As depicted in FIG. 8, a plurality of flat disc-shaped compressed compacts may be threaded onto the snap line fastener, thereby providing the user with the option of increasing or decreasing the overall weight of the sinker by selecting the number of discs which are threaded onto the snap line fastener. As desired, the weight (of size) of individual ones of the discs may be varied, thereby providing a user with the opportunity to select from a very large range of overall weights for a given sinker.

As seen in FIG. 10, in one embodiment of the present invention, a compressed compact of the present invention a wire fastener 64 may be threaded through the throughbore of the compressed compact, bent back upon the compressed compact and ultimately connected to itself to capture the compressed compact on the wire fastener. One end 66 of the wire fastener is adapted to be connected to a fishing line so that the fishing line never is subjected to chaffing etc. by reason of the line engaging a rim of the throughbore. As seen in FIG. 11, the compressed compact may be provided with a groove 68 extending along its outer surface 70 and between its opposite ends to provide a region of capture of a wire fastener within such groove as depicted in FIG. 11. In either of the embodiments of FIG. 10 or 11, there is no need for a liner within the throughbore.

In a further embodiment of a sinker which comprises a throughbore extending between the opposite ends of a hollow tubular compressed compact may be formed with generally planar fins projecting from the outer surface of the compressed compact. If desired, the fins may be helically oriented from end to end thereby causing the sinker to rotate about its longitudinal centerline when the sinker is pulled or allowed to freely fall through the water while in use by a fisherman.

In each embodiment of the present invention, following die forming of a sinker or lure, it may be provided with an outer covering 72 of a paint or a polymeric material, as desired, (See FIG. 5, for example) for purposes of protection of the sinker or lure when it might strike a sharp and/or hard surface such as rocks in a lake or river bed. Colored coatings may be employed for identifying specific overall weights of the sinkers or lures, and/or as a fish attractant. One outer covering may be powdered material applied to the outer surface of the article, for example a metal powder. In any event, such outer covering may serve as a deterrent to fracture, disintegration, or other deleterious effect occasioned by the use of the article, such as upon the article striking a rock or other hard surface during use of the article.

In one embodiment of the present invention, when using powdered tungsten metal mixed with a lighter powdered metal, one may choose the lighter metal powder to have a melting point less than the melting point of the tungsten. After this powder mix is formed into a desired compact, the compact may be heated to drive off substantially all or a selected portion of the lighter metal powder, leaving substantial voids spread throughout the compact, i.e. the compressed compact becomes a porous product. This technique may be employed to develop an essentially 100% tungsten sinker of a given size which weighs less than if the sinker were made of only compacted powdered tungsten metal, but which exhibits the physical properties of essentially only the tungsten. In one embodiment, the voids of such compact may be subsequently partially or substantially fully filled with a liquid or flowable material such as a polymeric material, as desired, to provide strengthening of the tungsten powder matrix and/or for the incorporation into the sinker a quantity of a fish attractant. Such added material further may be colored to impart a desired visual impression to the sinker. In this instance, the sinker may in fact become the lure for attracting fish. Thus, fishing lures of various overall weights, colors, etc. and which are of a preselected overall density (weight) may be formed employing the concepts of the present invention.

In a further embodiment of the method of the present invention, the powdered metal may be admixed with a dry adhesive which is heat activated and a quantity of the mixture die formed into an article of the present invention. As the mixture is pressed into a compressed compact, heat generated by the pressing action is employed to activate the dry adhesive, which, upon cooling, bonds the individual powder particulates together into a self-supporting compressed having a geometry determined by the cavity defined in the die within which the compact is formed.

Whereas the invention has been described herein primarily in terms of geometrical shapes, modes of line connection to the weight, and like details, it is understood that one skilled in the art will recognize many alternatives of the present invention are permissible employing the various aspects of the present invention. Accordingly, it is intended that the scope of the present invention is to be limited only as set forth in the Claims attached hereto.

What is claimed:

1. An article of fishing tackle comprising:
a quantity of a powder die-formed into compressed self-supporting compact of a preselected geometry.

2. The article of claim 1 wherein said powder comprises a metal powder.

3. The article of claim 2 wherein said metal is a heavy metal.

4. The article of claim 1 and including a further powder and said further powder are mixed together prior to being compressed.

5. The article of claim 2 and including a quantity of a further powdered metal mixed with said metal powder to define a mixture of said metal powder and said further metal powder.

6. The article of claim 5 and including a quantity of a micronized polymeric powder intermixed with said heavy metal powders.

7. The article of claim 6 wherein said micronized polymeric powder comprises micronized polyethylene.

8. The article of claim 6 wherein said polymeric material is polyethylene.

9. The article of claim 5 wherein said further metal powder comprises between about 10% and about 99%, by weight, of the total weight of said metal powders of said mixture.

10. The article of claim 2 wherein said metal powder is tungsten metal powder.

11. The article of claim 6 wherein said micronized polymeric powder exhibits a particle size not substantially greater than 10 microns.

12. The article of claim 6 wherein said micronized polymeric powder is present in an amount not greater than 0.015%, by weight, of the total weight of said mixture of powders.

13. The article of claim 1 and including at least one throughbore extending through said article suitable for the passage of a conventional fishing line therethrough for attachment of the article to the conventional fishing line.

14. The article of claim 13 wherein said article is elongated and includes a longitudinal centerline and said throughbore is aligned with said longitudinal centerline.

15. The article of claim 14 and including a tubular member having open opposite ends and an inner wall extending between said open opposite ends, and residing within said throughbore, said opposite ends of said tubular member projecting from opposite open ends of said throughbore and overwrapping respective ones of said open ends of said tubular member whereby said tubular member effectively covers said opposite ends of said throughbore and said inner wall of said throughbore.

16. The article of claim 2 wherein said heavy metal powder is present in the article in the form of multiple annular disc-type compressed compacts, said disc-type compressed compacts being stacked one upon another to define an elongated sinker having a central open passageway defined between the opposite ends thereof.

17. The article of claim 2 wherein said heavy metal powder is a compressed compact in the form of a tear drop geometry.

18. The article of claim 1 and including an outer covering comprising a polymeric material.

19. The article of claim 1 and including an outer covering comprising a powdered metal.

20. The article of claim 5 wherein said further metal exhibits a melting point less than the melting point of said metal powder.
